(19) United States
(12) Patent Application Publication
(10) Pub. No.: US 2024/0424426 A1
(43) Pub. Date: Dec. 26, 2024

(54) SOLVENTS FOR SELECTIVE COMPLEXATION OF METAL CATIONS

(71) Applicant: THE BOARD OF TRUSTEES OF THE UNIVERSITY OF ALABAMA, Tuscaloosa, AL (US)

(72) Inventors: Jason E. Bara, Tuscaloosa, AL (US); Steven Thomas Weinman, Tuscaloosa, AL (US)

(21) Appl. No.: 18/636,745

(22) Filed: Apr. 16, 2024

Related U.S. Application Data
(60) Provisional application No. 63/508,594, filed on Jun. 16, 2023.

(51) Int. Cl. B01D 11/04

(52) U.S. Cl. CPC B01D 11/0492; B01D 2257/60

(57) ABSTRACT

Disclosed herein are compositions and methods for the extraction of metals from aqueous liquids. Disclosed are chelating solvents that selectively extract one or more metal ions from an aqeuous solution.

### CROSS-REFERENCE TO RELATED APPLICATION

This application claims the benefit of U.S. Provisional Application 63/508,594, filed Jun. 16, 2023, the contents of which are hereby incorporated in its entirety.

### ACKNOWLEDGEMENT OF GOVERNMENT SUPPORT

This invention was made with government support under Grant No. 2029387 awarded by the National Science Foundation. The government has certain rights in the invention.

### FIELD OF THE INVENTION

The invention relates to compounds and methods for selectively extracting metals from aqueous liquids.

### BACKGROUND

Currently, 55-60% of global lithium production is through extraction of Li⁺ salts from underground brine reservoirs. Lithium salts are critical materials, as the U.S. market for Li⁺-ion batteries is forecasted to grow by 18% annually over the next eight years. Currently, lithium is largely imported, although significant Li⁺ resources exist in the U.S. Thus new, innovative technologies are needed to recover domestic Li⁺ from brines.

The U.S. has large domestic sources of Li⁺ within geothermal fluids, particularly at the Salton Sea in California. Li⁺ extraction from geothermal brines offers the potential to provide the U.S. with a secure, domestic supply of lithium to meet the increasing demands of electric vehicles (EV), grid energy storage, consumer electronics, and other end-use applications. The 2020 U.S. Geological Survey (USGS) Mineral Commodities Summary estimated that 65% of global lithium end use is for Li⁺-ion batteries, and this market is expected to grow rapidly in coming years. Between 2015-2019, >50% of the US lithium supply was imported, primarily from Argentina, Chile, and China, who along with Australia, produce most of the global lithium through brine and hardrock mining.

The Salton Sea has a relatively high concentration of Li⁺ and a unique Mg²⁺/Li⁺ ratio of 0.76. Brine flow from the Salton Sea wellhead was ˜121.3 Mt in 2019. A conservative estimate of the average Li⁺ concentration in this geothermal brine is 200 mg/L (˜200 ppm). This represents an estimated lithium throughput of ˜24 kt/yr that can be converted to nearly 127,000 t/yr of Li₂CO₃. U.S. lithium consumption from 2015-2019 was estimated as 2-3 kt/yr (˜16 kt/yr Li₂CO₃). The estimated current lithium resources of the Salton Sea are 15 Mt, and its full development could produce >600 kt/yr of Li₂CO₃.

Direct lithium extraction (DLE) from geothermal brines and other sources can be achieved through a variety/combination of techniques/processes to produce final lithium products. Generally, these are classified as adsorption, ion exchange, and solvent extraction using one or more-unit operations and various media including precipitation, adsorption, solvent, ionic liquids (ILs), membranes, electrochemistry, and chromatography. Currently, adsorption and ion exchange have advanced to pilot-and near-commercial-scale operations. In evaporative brine operations, Li⁺-containing brines are pumped to a series of large surface ponds to evaporate water over a period of months. When the desired Li⁺ concentration is reached, the brine is extracted and filtered to remove unwanted BO₃⁻ and Mg(OH)₂. When the Mg²⁺/Li⁺ ratio is <6, the solution is treated with Na₂CO₃ to precipitate the Li⁺. These processes require expensive capital investments, often result in poor recovery, and because most brines have a Mg²⁺/Li⁺ ratio>6, result in the loss of lithium. Thus, direct extraction technologies will provide a more sustainable lithium supply in terms of reductions in land and water use, lithium product time to market, and associated CO₂ emissions.

Adsorption processes physically adsorb LiCl molecules onto the surface of a sorbent from a lithium-rich solution, with water as a potential stripping solution. Ion exchange extracts Li⁺ ions from the solution by trading Li⁺ for H⁺ or other cations within the sorbent structure, with an acid solution (typically aq. HCl) typically used to strip and recover lithium. Solvent extraction exchanges LiCl molecules or Li⁺ ions from the brine to the organic phase. For successful deployment, DLE techniques (alone or in combination with additional process steps) must be able to extract Li⁺ from complex brines with high concentrations of other cations such as Na⁺, K⁺, Ca²⁺, Mg²⁺, and anions such as borates and sulfates. For geothermal brines, silica, and other species may be present (e.g., iron and manganese in Salton Sea brines). Solvent extraction is able to selectively and quantitatively extract Li⁺ salts from aq. solutions. The organic solvent comprises: extractant (metal chelation); synergistic co-extractant (adduct formation); and diluent/bulk solvent (e.g., xylene, dodecane).

Crown ethers are the most Li⁺-selective extractant molecules, functioning through electrostatic interactions between Li⁺ and the lone pairs of the ether O atoms within the relatively rigid macrocycle. The selectivity of crown ethers towards alkali metal cations (i.e., Li⁺, Na⁺, K⁺, Rb⁺, Cs⁺) depends on ring/cavity size, and Li⁺ affinity decreases with increasing ring size. Crown ethers of 15-crown-5 or smaller are selective for Li⁺; while 12-crown-4 and 14-crown-4 structures have the greatest selectivity for Li⁺ over competing cations.

There have been many approaches reported on the use of crown ethers in the laboratory for Li⁺ extraction from aq. solutions. These include attaching crown ethers to carbon nanotubes to improve extraction performance, as well as the integration of crown ethers with extraction by ILs or supercritical fluids. Functionalization of crown ethers with a range of polar/ionic pendant groups/side arms can enhance bonding of Li⁺. Polymers containing crown ethers have also been studied for Li⁺ extraction. While crown ethers show promise in the laboratory, major barriers exist in their commercial use on geothermal brines. Perhaps the largest challenge with crown ethers is their high synthesis/manufacturing cost, which also severely limits applied research with crown ethers on real brines, such as the need for pretreatment.

Electric Vehicles (EVs) and other clean energy technology require the use of rare earth elements (REEs). Foreign entities are the nearly exclusive source of REEs, and it is imperative that domestic supply chains are secured. Permanent magnets for EVs, turbines, phones, tablets, and computer hard disk drives are reliant on REEs, specifically Neodymium (Nd). Nd-iron-boron (Nd—Fe—B) magnets are the most common magnets and contain approximately 30 wt. % Nd. These magnets can contain other critical and REEs, such as cobalt (Co), dysprosium (Dy), and praseodymium (Pr)) depending on the magnet's specific application. Recycling these Nd—Fe—B magnets will supplement the need for reliance on foreign entities for REEs. However, current commercial recycling methods are limited, costly, and environmentally hazardous, such that essentially no Nd metal is produced in the U.S. The traditional recovery of Nd from used magnets involves a complicated process involving acid leaching, a series of solvent extractions, Nd complexation and precipitation, calcination, and chloride conversion. This process produces dangerous perfluorocarbons and CO₂, making it environmentally undesirable.

There remains a need for improved compositions and methods for the extraction of valuable metals from liquids, including aqueous liquids. There remains a need for improved compositions and methods for extracting lithium from aqueous liquids, including geothermal brines. There remains a need for improved compositions and methods for the extraction of rare earth elements, including in the context of recycling and waste streams. There remains a need for improved compositions and methods for extracting metals from permanent magnets. There remains a need for improved compositions and methods for obtaining neodymium from scrapped and spent permanent magnets.

### DETAILED DESCRIPTION

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes¬from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or

circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

Compounds disclosed herein may be provided in the form of salts. Examples of such salts are acid addition salts formed with inorganic acids, for example, hydrochloric, hydrobromic, sulfuric, phosphoric, and nitric acids and the like; salts formed with organic acids such as acetic, oxalic, tartaric, succinic, maleic, fumaric, gluconic, citric, malic, methanesulfonic, p-toluenesulfonic, napthalenesulfonic, and polygalacturonic acids, and the like; salts formed from elemental anions such as chloride, bromide, and iodide; salts formed from metal hydroxides, for example, sodium hydroxide, potassium hydroxide, calcium hydroxide, lithium hydroxide, and magnesium hydroxide; salts formed from metal carbonates, for example, sodium carbonate, potassium carbonate, calcium carbonate, and magnesium carbonate; salts formed from metal bicarbonates, for example, sodium bicarbonate and potassium bicarbonate; salts formed from metal sulfates, for example, sodium sulfate and potassium sulfate; and salts formed from metal nitrates, for example, sodium nitrate and potassium nitrate.

As used herein, the term “null,” when referring to a possible identity of a chemical moiety, indicates that the group is absent, and the two adjacent groups are directly bonded to one another. By way of example, for a genus of compounds having the formula CH₃—X—CH₃, if X is null, then the resulting compound has the formula CH₃—CH₃.

A bracketed functional group with a subscripted variable that is selected from 0 or 1 should be interpreted as follows:

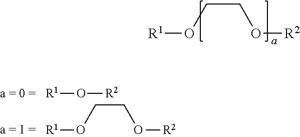

Disclosed herein are metal complexing compounds of Formula (1):

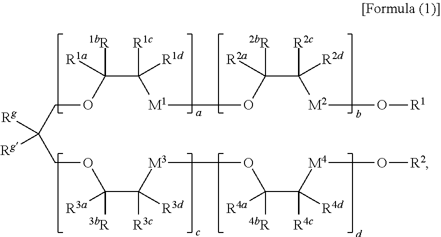

wherein R^{g} and R^{g′} together form an oxo (i.e., ═O), ═NR², or R^{g} is H and R^{g′} is OR² or NHR², wherein R^{z} has the formula:

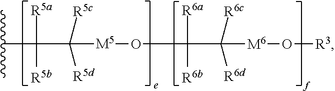

R¹ is H, C₁₋₆alkyl, aryl, C₁₋₆alkaryl, or C₁₋₆haloalkyl;
R² is H, C₁₋₆alkyl, aryl, C₁₋₆alkaryl, or C₁₋₆haloalkyl;
R³ is H, C₁₋₆alkyl, aryl, C₁₋₆alkaryl, or C₁₋₆haloalkyl;
M¹ is null, CR^{1e}R^{1f}, or CR^{1e}R^{1f}CR^{1g}R^{1h};
M² is null, CR^{2e}R^{2f}, or CR^{2e}R^{2f}CR^{2g}R^{2h};
M³ is null, CR^{3e}R^{3f}, or CR^{3e}R^{3f}CR^{3g}R^{3h};
M⁴ is null, CR^{4e}R^{4f}, or CR^{4e}R^{4f}CR^{4g}R^{4h};
M⁵ is null, CR^{5e}R^{5f}, or CR^{5e}R^{5f}CR^{5g}R^{5h};
M⁶ is null, CR^{6e}R^{6f}, or CR^{6e}R^{6f}CR^{6g}R^{6h};
R^{1a}, R^{1b}, R^{1c}, R^{1d}, R^{1e}, R^{1f}, R^{1g}, R^{1h}, R^{2a}, R^{2b}, R^{2c}, R^{2d}, R^{2e}, R^{2f}, R^{2g}, R^{2h}, R^{3a}, R^{3b}, R^{3c}, R^{3d}, R^{3e}, R^{3f}, R^{3g}, R^{3h} R^{4a}, R^{4b}, R^{4c}, R^{4d}, R^{5a}, R^{5b}, R^{5c}, R^{5d}, R^{5e}, R^{5f}, R^{5g}, R^{5h}, R^{6a}, R^{6b}, R^{6c}, R^{6d}, R^{6e}, R^{6f}, R^{6g}, and R^{6h} are each independently selected from H, CH₃, F, CH₂F, CHF₂, or CF₃; and
a, b, c, d, e, and f are each independently selected from 0 or 1, provided that the sum of [a+b+c+d+e+f] is 2 or more.

In certain implementations, the sum of [a+b+c+d+e+f] is 2. In certain implementations, the sum of [a+b+c+d+e+f] is 3. In certain implementations, the sum of [a+b+c+d+e+f] is 4. In certain implementations, the sum of [a+b+c+d+e+f] is 5. In certain implementations, the sum of [a+b+c+d+e+f] is 6.

In some implementations each R^{x} group (i.e., R^{1a}, R^{1b}, R^{1c}, R^{1d}, R^{1e}, R^{1f}, R^{1g}, R^{1h}, R^{2a}, R^{2b}, R^{2c}, R^{2d}, R^{2e}, R^{2f}, R^{2g}, R^{2h}, R^{3a}, R^{3b}, R^{3c}, R^{3d}, R^{3e}, R^{3f}, R^{3g}, R^{3h} R^{4a}, R^{4b}, R^{4c}, R^{4d}, R^{5a}, R^{5b}, R^{5c}, R^{5d}, R^{5e}, R^{5f}, R^{5g}, R^{5h}, R^{6a}, R^{6b}, R^{6c}, R^{6d}, R^{6e}, R^{6f}, R^{6g}, and R^{6h}) present in the compound is H. In some implementations each R^{x} group is F. In some implementations, each R^{xa} group (i.e., R^{1a}, R^{2a}, R^{3a}, R^{4a}, R^{5a}, R^{6a}) present in the compound is CH₃, while each R^{xb}, R^{xc}, R^{xd}, R^{xe}, R^{xf} group is H.

In certain implementations R¹, R², and R³ can be independently selected from CH₃, CH(CH₃)₂, CF₃, CH₂CF₃, benzyl, or phenyl. In certain implementations, R¹, R², and R³ are each the same. In some implementations, R¹ and R² are each the same and R³ is different from R¹ and R². In some implementations, R² and R³ are each the same and R¹ is different from R² and R³. In some implementations R^{g} and R^{g′} together form an oxo, and R¹ and R² are each the same. In other implementations, R^{g} and R^{g′} together form an oxo, and R¹ and R² are not the same.

In certain implementations, R^{g} and R^{g′} together form an oxo, and R¹ is CH₃ or CH(CH₃)₂, and R² is CH₂CF₃. In other implementations, R^{g} and R^{g′} together form an oxo, and R¹ and R² both CH(CH₃)₂.

In certain implementations, R¹ and R² are each CH(CH₃)₂, and R³ is CH₂CF₃. In certain implementations, R² and R³ are each CH(CH₃)₂, and R¹ is CH₂CF₃. In certain implementations, R¹ and R² are each CH₃, and R³ is CH₂CF₃. In certain implementations, R² and R³ are each CH₃, and R¹ is CH₂CF₃.

In some implementations, the compound can have a water solubility (at 23° C., 1 atm) of no more than 100 mg/mL, no more than 50 mg/mL, no more than 25 mg/mL, no more than 10 mg/mL, no more than 5 mg/mL, no more than 1 mg/mL, no more than 0.5 mg/mL, no more than 0.1 mg/ml. The skilled person can adjust the water solubility of the disclosed compound using fluoro and other hydrophobic substituents.

In certain implementations, b and d are both 0. In some implementations, the compound is a compound of Formula (2):

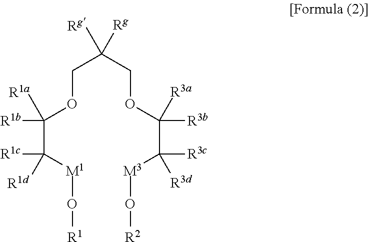

In certain implementations of the compound of Formula (2), M¹ and M² are both null.

In certain implementations of the compound of Formula (2), M¹ and M² are both null, and R^{1a}, R^{1b}, R^{1c}, R^{1d}, R^{3a}, R^{3b}, R^{3c}, and R^{3d} are each H. In certain implementations of the compound of Formula (2), M¹ and M² are both null, and R^{1a}, R^{1b}, R^{1c}, R^{1d}, R^{3a}, R^{3b}, R^{3c}, and R^{3d} are each F. In certain implementations of the compound of Formula (2), M¹ and M² are both null, R^{1a}, R^{1c}, R^{3a}, and R^{3c} are each F, and R^{1b}, R^{1d}, R^{3b}, and R^{3d} are each H. In certain implementations of the compound of Formula (2), M¹ and M² are both null, and R^{1a} and R^{3a} are each CH₃, and R^{1b}, R^{1c}, R^{1d}, R^{3b}, R^{3c}, and R^{3d} are each H.

In certain implementations of the compound of Formula (2), R^{g} and R^{g′} together form an oxo. In other implementations of the compound of Formula (2), R^{g} is H and R^{g′} is OR³. In some embodiments, R³ can be CH₃, CH(CH₃)₂, CF₃, CH₂CF₃, benzyl, or phenyl.

In certain implementations, a and b are both 0. In some implementations, the compound is a compound of Formula (3):

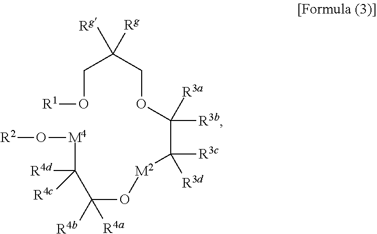

In certain implementations of the compound of Formula (3), M² and M⁴ are both null.

In certain implementations of the compound of Formula (3), M² and M⁴ are both null, and R^{3a}, R^{3b}, R^{3c}, R^{3d}, R^{4a}, R^{4b}, R^{4c}, and R^{4d} are each H. In certain implementations of the compound of Formula (2), M² and M⁴ are both null, and R^{3a}, R^{3b}, R^{3c}, R^{3d}, R^{4a}, R^{4b}, R^{4c}, and R^{4d} are each F. In certain implementations of the compound of Formula (3), M² and M⁴ are both null, R^{3a}, R^{3c}, R^{4a}, and R^{4c} are each F, and R^{3b}, R^{3d}, R^{4b}, and R^{4d} are each H. In certain implementations of the compound of Formula (3), M² and M⁴ are both null, and R^{3a} and R^{4a} are each CH₃, and R^{3b}, R^{3c}, R^{3d}, R^{4b}, R^{4c}, and R^{4d} are each H.

In certain implementations of the compound of Formula (3), R^{g} and R^{g′} together form an oxo. In other implementations of the compound of Formula (3), R^{g} is H and R^{g′} is OR³. In some embodiments, R³ can be CH₃, CH(CH₃)₂, CF₃, CH₂CF₃, benzyl, or phenyl.

In certain implementations, a and b are both 0, and R^{g′} is OR² or NHR². In certain implementations, the compound is a compound of Formula (4):

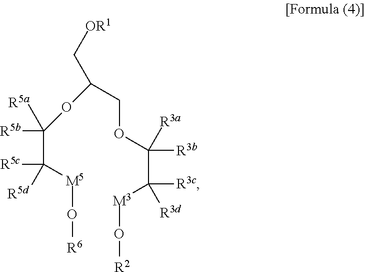

In certain implementations of the compound of Formula (4), M³ and M⁵ are both null.

In certain implementations of the compound of Formula (4), M³ and M⁵ are both null, and R^{3a}, R^{3b}, R^{3c}, R^{3d}, R^{5a}, R^{5b}, R^{5c}, and R^{5d} are each H. In certain implementations of the compound of Formula (2), M² and M⁵ are both null, and R^{3a}, R^{3b}, R^{3c}, R^{3d}, R^{5a}, R^{5b}, R^{5c}, and R^{5d} are each F. In certain implementations of the compound of Formula (2), M³ and M⁵ are both null, R^{3a}, R^{3c}, R^{5a}, and R^{5c} are each F, and R^{3b}, R^{3d}, R^{5b}, and R^{5d} are each H. In certain implementations of the compound of Formula (3), M² and M⁵ are both null, and R^{3a} and R^{5a} are each CH₃, and R^{3b}, R^{3c}, R^{3d}, R^{5b}, R^{5c}, and R^{5d} are each H.

In certain implementations of the compound of Formula (4), R¹ can be CH₃, CH(CH₃)₂, CF₃, CH₂CF₃, benzyl, or phenyl.

In certain implementations, a, c, and d are each 1, and b is 0. In certain implementations, the compound is a compound of Formula (5):

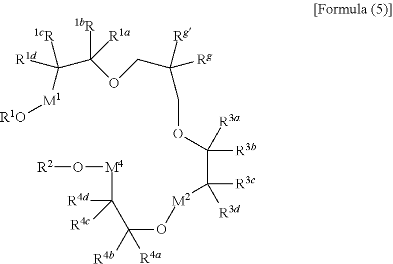

In certain implementations of the compound of Formula (5), M¹, M², and M⁴ are each null.

In certain implementations of the compound of Formula (5), M¹, M², and M⁴ are each null, and R^{1a}, R^{1b}, R^{1c}, R^{1d}, R^{3a}, R^{3b}, R^{3c}, R^{3d}, R^{4a}, R^{4b}, R^{4c}, and R^{4d} are each H. In certain implementations of the compound of Formula (5), M¹, M², and M⁴ are each null, and R^{1a}, R^{1b}, R^{1c}, R^{1d}, R^{3a}, R^{3b}, R^{3c}, R^{3d}, R^{4a}, R^{4b}, R^{4c}, and R^{4d} are each F. In certain implementations of the compound of Formula (5), M¹, M², and M⁴ are each null, R^{1a}, R^{1c}, R^{3a}, R^{3c}, R^{4a}, and R^{4d} are each F, and R^{1b}, R^{1d}, R^{3b}, R^{3d}, R^{4b}, and R^{4d} are each H. In certain implementations of the compound of Formula (5), M¹, M², and M⁴ are each null, and R^{1a}, R^{3a}, and R^{4a} are each CH₃, and R^{1b}, R^{1c}, R^{1d}, R^{3b}, R^{3c}, R^{3d}, R^{4b}, R^{4c}, and R^{4d} are each H.

In certain implementations of the compound of Formula (5), R^{g} and R^{g′} together form an oxo. In other implementations of the compound of Formula (5), R^{g} is H and R^{g′} is OR³. In some embodiments, R³ can be CH₃, CH(CH₃)₂, CF₃, CH₂CF₃, benzyl, or phenyl.

In certain implementations, a and b are both 0, and c, d, and e are each 1. In certain implementations, the compound is a compound of Formula (6):

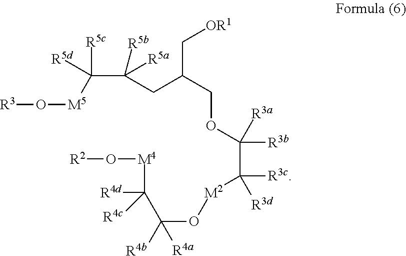

In certain implementations of the compound of Formula (6), M², M⁴, and M⁵ are each null, and R^{3a}, R^{3b}, R^{3c}, R^{3d}, R^{4a}, R^{4b}, R^{4c}, R^{4d}, R^{5a}, R^{5b}, R^{5c}, and R^{5d} are each H. In certain implementations of the compound of Formula (6), M², M⁴, and M⁵ are each null, and R^{3a}, R^{3b}, R^{3c}, R^{3d}, R^{4a}, R^{4b}, R^{4c}, R^{4d}, R^{5a}, R^{5b}, R^{5c}, and R^{5d} are each F. In certain implementations of the compound of Formula (6), M², M⁴, and M⁵ are each null, R^{3a}, R^{3c}, R^{4a}, R⁴C, R^{5a}, and R^{5d} are each F, and R^{3b}, R^{3d}, R^{4b}, R^{4d}, R^{5b}, and R^{5d} are each H In certain implementations of the compound of Formula (6), M², M⁴, and M⁵ are each null, and R^{3a}, R^{4a}, and R^{5a} are each CH₃, and R^{4b}, R^{4c}, R^{4d} R^{4b}, R^{4c}, R^{4d} R^{5b}, R^{5c}, and R^{5d} are each H.

In certain implementations of the compound of Formula (6), R¹ can be CH₃, CH(CH₃)₂, CF₃, CH₂CF₃, benzyl, or phenyl.

In certain implementations, a, b, c, and d are each 1. In certain implementations, M¹, M², M³, and M⁴ are each null. In certain implementations, the compound is a compound of Formula (7):

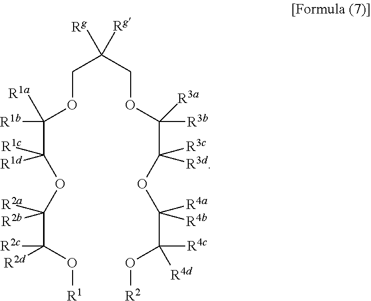

In certain implementations of the compound of Formula (7) R^{1a}, R^{1b}, R^{1c}, R^{1d}, R^{2a}, R^{2b}, R^{2c}, R^{2d}, R^{3a}, R^{3b}, R^{3c}, R^{3d}, R^{4a}, R^{4b}, R^{4c}, and R^{4d} are each H. In certain implementations of the compound of Formula (7) R^{1a}, R^{1b}, R^{1c}, R^{1d}, R^{2a}, R^{2b}, R^{2c}, R^{2d}, R^{3a}, R^{3b}, R^{3c}, R^{3d}, R^{4a}, R^{4b}, R^{4c}, and R^{4d} are each F. In certain implementations of the compound of Formula (7), R^{1a}, R^{1c}, R^{2a}, R^{2c}, R^{3a}, R^{3c}, R^{4a}, and R^{4d} are each F, and R^{1b}, R^{1d}, R^{2a}, R^{2c}, R^{3b}, R^{3d}, R^{4b}, and R^{4d} are each H. In certain implementations of the compound of Formula (7) R^{1a}, R^{2a}, R^{3a}, and R^{4a} are each CH₃, and R^{1b}, R^{1c}, R^{1d}, R^{2b}, R^{2c}, R^{2d}, R^{3b}, R^{3c}, R^{3d}, R^{4b}, R^{4c}, and R^{4d} are each H.

In certain implementations of the compound of Formula (7), R^{g} and R^{g′} together form an oxo. In other implementations of the compound of Formula (7), R^{g} is H and R^{g′} is OR³. In some embodiments, R³ can be CH₃, CH(CH₃)₂, CF₃, CH₂CF₃, benzyl, or phenyl.

In certain implementations, c, d, e, and f are each 1. In certain implementations, M³, M⁴, M⁵, and M⁶ are each null. In certain implementations, the compound is a compound of Formula (8):

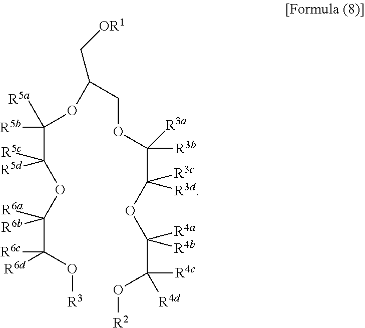

In certain implementations of the compound of Formula (8) R^{3a}, R^{3b}, R^{3c}, R^{3d}, R^{4a}, R^{4b}, R^{4c}, R^{4d}, R^{5a}, R^{5b}, R^{5c}, R^{5d}, R^{6a}, R^{6b}, R^{6c}, and R^{6d} are each H. In certain implementations of the compound of Formula (8) R^{3a}, R^{3b}, R^{3c}, R^{3d}, R^{4a}, R^{4b}, R^{4c}, R^{4d}, R^{5a}, R^{5b}, R^{5c}, R^{5d}, R^{5a}, R^{6b}, R^{6c}, and R^{5d} are each F. In certain implementations of the compound of Formula (8), R^{3a}, R^{3c}, R^{4a}, R^{4c}, R^{5a}, R^{5c}, R^{5a}, and R^{5d} are each F, and R^{3b}, R^{3d}, R^{4a}, R^{4c}, R^{5b}, R^{5d}, R^{6b}, and R^{6d} are each H. In certain implementations of the compound of Formula (7) R^{3a}, R^{4a}, R^{5a}, and R^{6a} are each CH₃, and R^{3b}, R^{3c}, R^{3d}, R^{4b}, R^{4c}, R^{4d}, R^{5b}, R^{5c}, R^{5d}, R^{6b}, R^{6c}, and R^{6d} are each H.

In certain implementations of the compound of Formula (8), R^{g} and R^{g′} together form an oxo. In other implementations of the compound of Formula (8), R^{g} is H and R^{g′} is OR¹. In some embodiments, R¹ can be CH₃, CH(CH₃)₂, CF₃, CH₂CF₃, benzyl, or phenyl.

In certain implementations:

R^{1a} is H, CH₃, F, CH₂F, CHF₂, or CF₃;
R^{1b} is H, CH₃, F, CH₂F, CHF₂, or CF₃;
R^{1c} is H, CH₃, F, CH₂F, CHF₂, or CF₃;
R^{1d} is H, CH₃, F, CH₂F, CHF₂, or CF₃;
M¹ is null, CR^{1e}R^{1f}, or CR^{1e}R^{1f}CR^{1g}R^{1h};
R^{1e} is H, CH₃, F, CH₂F, CHF₂, or CF₃;
R^{1f} is H, CH₃, F, CH₂F, CHF₂, or CF₃;
R^{1g} is H, CH₃, F, CH₂F, CHF₂, or CF₃;
R^{1h} is H, CH₃, F, CH₂F, CHF₂, or CF₃;
a is 1 or 0;
R^{2a} is H, CH₃, F, CH₂F, CHF₂, or CF₃;
R^{2b} is H, CH₃, F, CH₂F, CHF₂, or CF₃;
R^{2c} is H, CH₃, F, CH₂F, CHF₂, or CF₃;
R^{2d} is H, CH₃, F, CH₂F, CHF₂, or CF₃;
M² is null, CR^{2e}R^{2f}, or CR^{2e}R^{2f}CR^{2g}R^{2h};
R^{2e} is H, CH₃, F, CH₂F, CHF₂, or CF₃;
R^{2f} is H, CH₃, F, CH₂F, CHF₂, or CF₃;
R^{2g} is H, CH₃, F, CH₂F, CHF₂, or CF₃;
R^{2h} is H, CH₃, F, CH₂F, CHF₂, or CF₃;
b is 1 or 0;
R^{3a} is H, CH₃, F, CH₂F, CHF₂, or CF₃;
R^{3b} is H, CH₃, F, CH₂F, CHF₂, or CF₃;
R^{3c} is H, CH₃, F, CH₂F, CHF₂, or CF₃;
R^{3d} is H, CH₃, F, CH₂F, CHF₂, or CF₃;
M³ is null, CR^{3e}R^{3f}, or CR^{3e}R^{3f}CR^{3g}R^{3h};
R^{3e} is H, CH₃, F, CH₂F, CHF₂, or CF₃;
R^{3f} is H, CH₃, F, CH₂F, CHF₂, or CF₃;
R^{3g} is H, CH₃, F, CH₂F, CHF₂, or CF₃;
R^{3h} is H, CH₃, F, CH₂F, CHF₂, or CF₃;
c is 1 or 0;
R^{4a} is H, CH₃, F, CH₂F, CHF₂, or CF₃;
R^{4b} is H, CH₃, F, CH₂F, CHF₂, or CF₃;
R^{4c} is H, CH₃, F, CH₂F, CHF₂, or CF₃;
R^{4d} is H, CH₃, F, CH₂F, CHF₂, or CF₃;
M⁴ is null, CR^{4e}R^{4f}, or CR^{4e}R^{4f}CR^{4g}R^{4h};
R^{4e} is H, CH₃, F, CH₂F, CHF₂, or CF₃;
R^{4f} is H, CH₃, F, CH₂F, CHF₂, or CF₃;
R^{4g} is H, CH₃, F, CH₂F, CHF₂, or CF₃;
R^{4h} is H, CH₃, F, CH₂F, CHF₂, or CF₃;
d is 1 or 0;
R^{5a} is H, CH₃, F, CH₂F, CHF₂, or CF₃;
R^{5b} is H, CH₃, F, CH₂F, CHF₂, or CF₃;
R^{5c} is H, CH₃, F, CH₂F, CHF₂, or CF₃;
R^{5d} is H, CH₃, F, CH₂F, CHF₂, or CF₃;
M⁵ is null, CR^{5e}R^{5f}, or CR^{5e}R^{5f}CR^{5g}R^{5h};
R^{5e} is H, CH₃, F, CH₂F, CHF₂, or CF₃;
R^{5f} is H, CH₃, F, CH₂F, CHF₂, or CF₃;
R^{5g} is H, CH₃, F, CH₂F, CHF₂, or CF₃;
R^{5h} is H, CH₃, F, CH₂F, CHF₂, or CF₃;
e is 1 or 0;
R^{6a} is H, CH₃, F, CH₂F, CHF₂, or CF₃;
R^{6b} is H, CH₃, F, CH₂F, CHF₂, or CF₃;
R^{6c} is H, CH₃, F, CH₂F, CHF₂, or CF₃;
R^{6d} is H, CH₃, F, CH₂F, CHF₂, or CF₃;
M⁶ is null, CR^{6e}R^{6f}, or CR^{6e}R^{6f}CR^{6g}R^{6h};
R^{6e} is H, CH₃, F, CH₂F, CHF₂, or CF₃;
R^{6f} is H, CH₃, F, CH₂F, CHF₂, or CF₃;
R^{6g} is H, CH₃, F, CH₂F, CHF₂, or CF₃;
R^{6h} is H, CH₃, F, CH₂F, CHF₂, or CF₃;
f is 1 or 0;

The compounds disclosed herein may be used to selectively extract metals from aqueous liquids. In certain implementations the compounds can be used to extract a metal ion dissolved in an aqueous liquid. In some implementations, the aqueous liquid is combined with the compound, the compound complexes the metal, and the metal-complexed compound is then separated from the aqueous liquid, for example using liquid/liquid extraction. The metal ion may be separated from the metal-complexed compound via precipitation or chemical reaction. In certain implementations, the metal-complexed compound is treated with an acid to precipitate the metal ion as a salt. In certain implementations the acid is a mineral acid like HCl, HNO₃, H₂SO₄, or H₃PO₄. In some implementations the acid is carbonic acid (H₂CO₃) or acetic acid. In some implementations the acid in an anhydrous acid, for example gaseous HCl. In some implementations, the metal ion is precipitated by treatment or the metal-complexed compound with a base, for example sodium hydroxide or sodium carbonate.

The compounds disclosed herein may be used to extract a variety of useful metals. In some implementations, the compounds are used to extract metals in the +1 oxidation state, the +2 oxidation state, the +3 oxidation state, the +4 oxidation state, the +5 oxidation state, the +6 oxidation state, the +7 oxidation state, or a combination thereof. In certain implementations, the metal is Li, Al, Co, Cr, Cu, La, Mn, Ni, Y, Ce, La, Nd, Tb, Dy, Sc, Pr, Eu, Sm, Lu, Gd, Er, Ho, Tm, Yb, U, or a combination thereof. In certain implementations, the metal is Li⁺, Al³⁺, Co²⁺, Cr³⁺, Cu²⁺, La³⁺, Mn²⁺, Ni²⁺, Y³⁺, U⁴⁺, or a combination thereof. In one implementation the metal is Li⁺. In another implementation the metal is Nd³⁺.

The compounds can be used to extract metals from a variety of aqueous liquids. In certain implementations, the compounds can be used to extract metals from sea water, geothermal brines, or industrial waste streams.

In certain implementations the compounds may be combined with the aqueous liquids as a single component. A single compound can be used, or a mixture of compounds, depending on the target metal(s) to be extracted. In some implementations, the compound(s) may be combined with a diluent, for example a C₇₋₁₈hydrocarbon. In certain implementations the C₇₋₁₈hydrocarbon has a boiling point of at least 125° C. Suitable hydrocarbons include xylenes, mesitylenes, decanes, undecanes, dodecanes, and the like. In some implementations, the (v/v) ratio of compound(s) to diluent can be from 1:20 to 5:1, from 1:10 to 1:1, from 1:10 to 1:5, from 1:5 to 1:1, from 1:5 to 5:1, from 1:2.5 to 1:1.25, from 1:1 to 1:2.5, or from 1:1 to 1:5. In certain implementations, the (v/v) ratio of the compound(s) to diluent is about 10:1, about 5:1, about 3:1, or about 1:1.

Also disclosed herein are methods of obtaining a rare earth element using a compound of Formula (9):

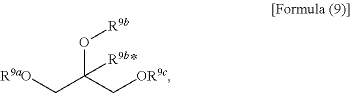

wherein
R^{9a} is H or C₁₋₁₂alkyl, optionally substituted one or more times by F, Cl, Br, or OC₁₋₄alkyl,
R^{9c} is H or C₁₋₁₂alkyl, optionally substituted one or more times by F, Cl, Br, or OC₁₋₄alkyl
R^{9b*} is H, R^{9b} is H or C₁₋₁₂alkyl, optionally substituted one or more times by F, Cl, Br, or OC₁₋₄alkyl or R^{9b*} and R^{9b} together form a bond,
wherein no more than one of R^{9a}, R^{9b}, and R^{9c} are H, and when R^{9b*} and R^{9b} together form a bond, neither of R^{9a} or R^{9c} are H.

In certain implementations, R^{9a} and R^{9c} are independently C₄₋₁₂alkyl, for example C₆₋₁₀alkyl, optionally substituted one or more times by F, Cl, Br, or OC₁₋₄alkyl. In some implementations, R^{9a} and R^{9c} are independently unsubstituted C₄₋₁₂alkyl, for example unsubstituted C₆₋₁₀alkyl. In certain implementations, R^{9a} and R^{9c} are independently a linear C₄₋₁₂alkyl, for example linear C₆₋₁₀alkyl, optionally substituted one or more times by F, Cl, Br, or OC₁₋₄alkyl. In some implementations, R^{9a} and R^{9c} are independently unsubstituted linear C₄₋₁₂alkyl, for example unsubstituted linear C₆₋₁₀alkyl. Exemplary unsubstituted linear alkyls include n-butyl, n-pentyl, n-hexyl, n-heptyl, n-octyl, n-nonyl, and n-decyl.

In some implementations R^{9b*} and R^{9b} together form a bond, and the compound of Formula (9) is a compound of Formula (9k):

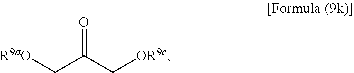

wherein R^{9a} and R^{9c} are as defined above.

In some implementations R^{9b*} and R^{9b} are both H, and compound of Formula (9) is a compound of Formula (9h):

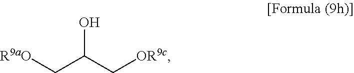

wherein R^{9a} and R^{9c} are as defined above.

In some implementations of the compound of Formula (9), (9k), and (9h), R^{9a} and R^{9c} are the same, for example a C₆alkyl, C₇alkyl, C₈alkyl, or C₉alkyl. In certain implementations, said C₆alkyl, C₇alkyl, C₈alkyl, or C₉alkyl are unsubstituted. In other implementations, said C₆alkyl, C₇alkyl, C₈alkyl, or C₉alkyl are substituted one or more times by F, Cl, Br, or OC₁₋₄alkyl. In other implementations, R^{9a} and R^{9c} are not the same. In certain implementations, R^{9a} is a C₁₋₄alkyl optionally substituted one or more times by F, Cl, Br, or OC₁₋₄alkyl, and R^{9c} is a C₅₋₁₂alkyl optionally substituted one or more times by F, Cl, Br, or OC₁₋₄alkyl.

In some implementations, the compound of Formula (9) is contacted with composition including Nd³⁺, preferably NdCl₃. The composition can be an aqeuous composition, for example a solution or suspension, which may include further solvents such as a C₁₋₄alcohol (methanol, ethanol, n-propanol, isopropanol, n-butanol, isobutanol, t-butanol, or a combination thereof). The aqeuous composition can include at least 80%, at least 85%, at least 90%, at least 95, or at least 99% (v/v) water relative to other solvents. Unless specified to the contrary, a solution including an Nd³⁺ species does not include insoluble materials. Such solutions may be obtained by filtering or otherwise separating a suspension from its non-dissolved components. The aqueous composition including Nd³⁺, preferably NdCl₃, can be an acidic composition. In certain implementations, the aqueous composition including Nd³⁺, preferably NdCl₃, has a pH less than 5, less than 4, less than 3, less than 2, or less than 1. In certain implementations, the aqueous composition including Nd³⁺, preferably NdCl₃, has a pH from 0-4, from 1-4, from 2-4, from 3-4 from 1-5, from 2-5, from 3-5, from 4-5, from 1-6, from 2-6, from 3-6, from 4-6, from 5-6, from 1 to less than 7, from 2 to less than 7, from 3 to less than 7, from 4 to less than 7, from 6 to less than 7, or from 6 to less than 7. In certain exemplary implementations, the aqueous composition including Nd³⁺ has a pH from 1-3.

In certain implementations, the aqeuous composition includes a mixture of Nd and Fe ions. In some implementations, the aqeuous composition includes Nd and Fe ions, wherein the molar ratio of Nd:Fe is from 50:1 to 1:1, from 25:1 to 1:1, from 25:1 to 5:1, from 25:1 to 10:1, from 20:1 to 5:1, from 20:1 to 10:1, from 15:1 to 5:1, from 10:1 to 5:1, or from 5:1 to 1:1.

The compound of Formula (9) is combined with the aqeuous composition including Nd³⁺, preferably NdCl₃, to complex Nd³⁺ ions. The compound of Formula (9), which is not miscible in water, may be combined with the aqeuous composition with agitation such as stirring or other mixing to facilitate the complexation process. The mixing produces an organic phase including the compound of Formula (9) and an aqueous phase. The aqueous phase may be separated from the organic phase including the compound of Formula (9) using conventional means. Following separation, the organic phase may be further treated with HCl to provide a purified NdCl₃ composition. In certain implementations, the organic phase is contacted with HCl (aq.) having a concentration from 0.01-2 M, from 0.1-2 M, from 0.1-1 M, from 0.1-0.5 M, from 0.5-1 M, from 1-2 M, or from 0.01-0.1 M.

In certain implementations, the extraction process disclosed herein is selective for Nd ions. In certain implementations, the organic phase includes at least 80 mol %, at least 85 mol %, at least 90 mol %, at least 95 mol %, or at least 99 mol %, Nd ions, relative to the total metal ions present in the organic phase. In certain implementations, the organic phase includes Fe ions in an amount that is less than 20 mol %, less than 15 mol %, less than 10 mol %, less than 5 mol %, less than 2.5 mol %, or less than 1 mol %, relative to the total metal ions present in the organic phase. In certain implementations, the organic phase includes Dy ions in an amount that is less than 5 mol %, less than 2.5 mol %, less than 1 mol %, less than 0.5 mol %, less than 0.1 mol %, or less than 0.01 mol %, relative to the total metal ions present in the organic phase.

The aqueous composition including Nd³⁺, preferably NdCl₃, can be obtained from treating a composition including an Nd^{o} material with an acid. The Nd⁰ material includes metals and metal alloys. The Nd⁰ material can be obtained from magnets, for example permanent magnets. In certain implementations the permanent magnet is an NdFeB magnet. NdFeB magnets are generally covered (clad) with a protecting shell including one or more nickel, copper, cobalt, chromium, etc. Methods are known by which a scrapped or spent magnet can be declad, demagnetized, and/or mechanically ground/crushed to give a composition including an unpurified Nd material. During this process, Nd⁰ is oxidized and may be converted to Nd₂O₃. In some implementations, the processing product includes a mixture of Nd⁰ and Nd₂O₃. In some implementations, at least 50 wt. %, at least 60 wt. %, at least 70 wt. %, at least 80 wt. %, at least 90 wt. %, or at least 95 wt. % of the Nd in composition is in the form of Nd₂O₃.

The processing product is then treated with an aqueous acid, for example HCl, to give an aqueous composition including Nd³⁺. The processing product may be combined with aqueous HCl to give a composition having a pH from 0-6, from 0-5, from 0-4, from 0-3, from 0-2, from 0-1, from 1-5, from 1-4, from 1-3, from 2-5 or from 3-5. The resulting composition may be combined with the compound of Formula (9) as described above.

### EXAMPLES

The following examples are for the purpose of illustration of the invention only and are not intended to limit the scope of the present invention in any manner whatsoever.

### Example 1

3 ml of the compound [F·Me·Me] was added neat to 3 mL of an aqueous solution containing 100 ppm LiCl and 100 ppm NaCl. After vigorous mixing of the organic and aqueous phases in a separatory funnel, the phases were separated, and the aqueous phase was analyzed using ion-selective electrodes for both Li⁺ and Na⁺. It was found that 26.6% of the Li⁺ was extracted by the compound, while only 7.3% of the Na⁺ was extracted.

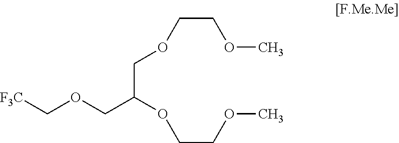 [SMILES: COCCOCC(COCC(F)(F)F)OCCOC]

### ADDITIONAL ASPECTS

A compound of Formula (1):

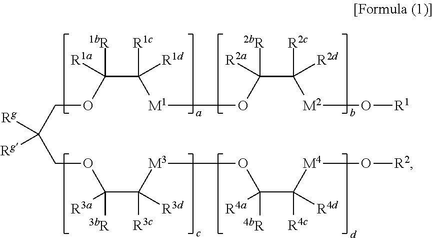

wherein R^{g} and R^{g′} together form an oxo (i.e., ═O), ═NR², or R^{g} is H and R^{g′} is OR^{z} or NHR^{z}, wherein R^{z} has the formula

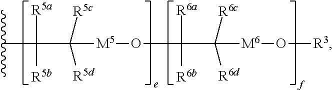

R¹ is H, C₁₋₆alkyl, aryl, C₁₋₆alkaryl, or C₁₋₆haloalkyl;
R² is H, C₁₋₆alkyl, aryl, C₁₋₆alkaryl, or C₁₋₆haloalkyl;
R³ is H, C₁₋₆alkyl, aryl, C₁₋₆alkaryl, or C₁₋₆haloalkyl;
M¹ is null, CR^{1e}R^{1f}, or CR^{1e}R^{1f}CR^{1g}R^{1h};
M² is null, CR^{2e}R^{2f}, or CR^{2e}R^{2f}CR^{2g}R^{2h};
M³ is null, CR^{3e}R^{3f}, or CR^{3e}R^{3f}CR^{3g}R^{3h};
M⁴ is null, CR^{4e}R^{4f}, or CR^{4e}R^{4f}CR^{4g}R^{4h};
M⁵ is null, CR^{5e}R^{5f}, or CR^{5e}R^{5f}CR^{5g}R^{5h};
M⁶ is null, CR^{6e}R^{6f}, or CR^{5e}R^{6f}CR^{6g}R^{6h};
R^{1a}, R^{1b}, R^{1c}, R^{1d}, R^{1e}, R^{1f}, R^{1g}, R^{1h}, R^{2a}, R^{2b}, R^{2c}, R^{2d}, R^{2e}, R^{2f}, R^{2g}, R^{2h}, R^{3a}, R^{3b}, R^{3c}, R^{3d}, R^{3e}, R^{3f}, R^{3g}, R^{3h} R^{4a}, R^{4b}, R^{4c}, R^{4d}, R^{5a}, R^{5b}, R^{5c}, R^{5d}, R^{5e}, R^{5f}, R^{5g}, R^{5h}, R^{6a}, R^{6b}, R^{6c}, R^{6d}, R^{6e}, R^{6f}, R^{6g}, and R^{6h} are each independently selected from H, CH₃, F, CH₂F, CHF₂, or CF₃; and
a, b, c, d, e, and f are each independently selected from 0 or 1, provided that the sum of [a+b+c+d+e+f] is 2 or more.

The compound according any preceding aspect, wherein M¹, M², M³, M⁴, M⁵, and M⁶ are each null.

The compound according any preceding aspect, wherein the sum of a+b+c+d+e+f is 2.

The compound according to any preceding aspect, wherein the sum of a+b+c+d+e+f is 3.

The compound according to any preceding aspect, wherein the sum of a+b+c+d+e+f is 4.

The compound according to any preceding aspect, wherein the sum of a+b+c+d+e+f is 5.

The compound according to any preceding aspect, wherein the sum of a+b+c+d+e+f is 6.

The compound according to any preceding aspect, wherein each R^{x} group present in the compound is H.

The compound according to any preceding aspect, wherein each R^{x} group present in the compound is F.

The compound according to any preceding aspect, wherein each R^{xa} group present in the compound is CH₃, and each R^{xb}, R^{xc}, R^{xd}, R^{xe}, R^{xf} group is H.

The compound according to any preceding aspect, wherein R¹ R², and R³ are independently selected from CH₃, CH(CH₃)₂, CF₃, CH₂CF₃, benzyl, or phenyl.

The compound according to any preceding aspect, wherein R¹, R², and R³ are each the same.

The compound according to any preceding aspect, wherein R¹ and R² are each the same and R³ is different from R¹ and R².

The compound according to any preceding aspect, wherein R² and R³ are each the same and R¹ is different from R² and R³.

The compound according to any preceding aspect, wherein R^{g} and R^{g′} together form an oxo, and R¹ and R² are not the same.

The compound according to any preceding aspect, wherein R^{g} and R^{g′} together form an oxo, and R¹ is CH₃ or CH(CH₃)₂, and R² is CH₂CF₃.

The compound according to any preceding aspect, wherein R^{g} and R^{g′} together form an oxo, and R¹ and R² both CH(CH₃)₂.

The compound according to any preceding aspect, wherein R¹ and R² are each CH(CH₃)₂, and R³ is CH₂CF₃.

The compound according to any preceding aspect, wherein R² and R³ are each CH(CH₃)₂, and R¹ is CH₂CF₃.

The compound according to any preceding aspect, wherein R¹ and R² are each CH₃, and R³ is CH₂CF₃.

The compound according to any preceding aspect, wherein R² and R³ are each CH₃, and R¹ is CH₂CF₃.

The compound according to any preceding aspect, wherein b and d are both 0.

The compound according to any preceding aspect, wherein the compound has the formula of Formula (2):

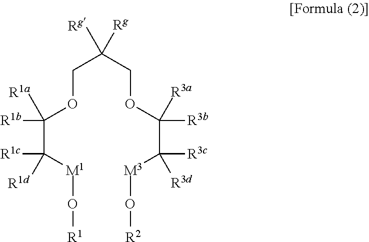

The compound according to any preceding aspect, wherein M¹ and M² are both null.

The compound according to any preceding aspect, wherein M¹ and M² are both null, and R^{1a}, R^{1b}, R^{1c}, R^{1d}, R^{3a}, R^{3b}, R^{3c}, and R^{3d} are each H.

The compound according to any preceding aspect, wherein M¹ and M² are both null, and R^{1a}, R^{1b}, R^{1c}, R^{1d}, R^{3a}, R^{3b}, R^{3c}, and R^{3d} are each F.

The compound according to any preceding aspect, wherein M¹ and M² are both null, R^{1a}, R^{1c}, R^{3a}, and R^{3c} are each F, and R^{1b}, R^{1d}, R^{3b}, and R^{3d} are each H.

The compound according to any preceding aspect, wherein M¹ and M² are both null, and R^{1a} and R^{3a} are each CH₃, and R^{1b}, R^{1c}, R^{1d}, R^{3b}, R^{3c}, and R^{3d} are each H.

The compound according to any preceding aspect, wherein R^{g} and R^{g′} together form an oxo.

The compound according to any preceding aspect, wherein a and b are both 0.

The compound according to any preceding aspect, wherein R^{g} and R^{g′} together form an oxo.

The compound according to any preceding aspect, wherein R^{g} is H, and X is O.

The compound according to any preceding aspect, wherein R^{1a}, R^{1b}, R^{1c}, R^{1d}, R^{3a}, R^{3b}, R^{3c}, and R^{3d} are each F.

The compound according to any preceding aspect, wherein R^{1a} and R^{3a} are each CH₃, and R^{1b}, R^{1c}, R^{1d}, R^{3b}, R^{3c}, and R^{3d} are each H.

The compound according to any preceding aspect, wherein R^{g} is H and R^{g!} is OR³.

The compound according to any preceding aspect, wherein R³ is CH₃, CH(CH₃)₂, CF₃, CH₂CF₃, benzyl, or phenyl.

The compound according to any preceding aspect, wherein R¹ is H, CH₃, CH₂CH₃, CH(CH₃)₂, CF₃, or CH₂CF₃.

The compound according to any preceding aspect, wherein R² is H, CH₃, CH₂CH₃, CH(CH₃)₂, CF₃, or CH₂CF₃.

The compound according to any preceding aspect, wherein R³ is H, CH₃, CH₂CH₃, CH(CH₃)₂, CF₃, or CH₂CF₃.

The compound according to any preceding aspect, wherein R¹ is CH₂CF₃, and R² and R³ are both CH₃.

The compound according to any preceding aspect, wherein R³ is CH₂CF₃ and R¹ and R² are both CH₃₂.

The compound according to any preceding aspect, wherein R³ is CH₃, and R¹ and R² are both CH(CH₃)₂.

The compound according to any preceding aspect, wherein R^{g} and R^{g′} together form an oxo, R¹ is CH₃, and R² is CH₂CF₃.

The compound according to any preceding aspect, wherein R² is CH₂CF₃.

The compound according to any preceding aspect, wherein R³ is CH₂CF₃.

The compound according to any preceding aspect, wherein the compound is a compound of Formula (3):

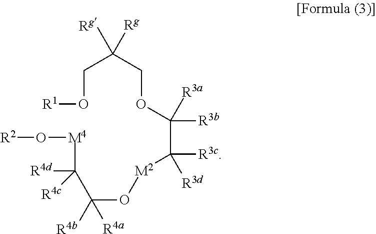

The compound according to any preceding aspect, wherein M² and M⁴ are both null

The compound according to any preceding aspect, wherein M² and M⁴ are both null, and R^{3a}, R^{3b}, R^{3c}, R^{3d}, R^{4a}, R^{4b}, R^{4c}, and R^{4d} are each H.

The compound according to any preceding aspect, wherein M² and M⁴ are both null, and R^{3a}, R^{3b}, R^{3c}, R^{3d}, R^{4a}, R^{4b}, R^{4c}, and R^{4d} are each F.

The compound according to any preceding aspect, wherein M² and M⁴ are both null, R^{3a}, R^{3c}, R^{4a}, and R^{4c} are each F, and R^{3b}, R^{3d}, R^{4b}, and R^{4d} are each H.

The compound according to any preceding aspect, wherein M² and M⁴ are both null, and R^{3a} and R^{4a} are each CH₃, and R^{3b}, R^{3c}, R^{3d}, R^{4b}, R^{4c}, and R^{4d} are each H.

The compound according to any preceding aspect, wherein R^{g} and R^{g′} together form an oxo.

The compound according to any preceding aspect, wherein R^{g} is H and R^{g′} is OR³.

The compound according to any preceding aspect, wherein R³ is CH₃, CH(CH₃)₂, CF₃, CH₂CF₃, benzyl, or phenyl

The compound according to any preceding aspect, wherein a and b are both 0, and R^{g′} is OR^{z} or NHR².

The compound according to any preceding aspect, wherein the compound is a compound of Formula (4):

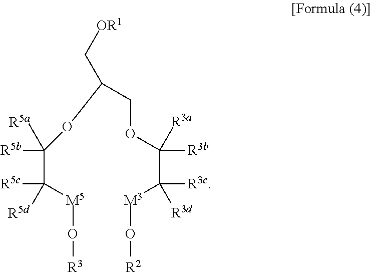

The compound according to any preceding aspect, wherein M³ and M⁵ are both null.

The compound according to any preceding aspect, wherein M³ and M⁵ are both null, and R^{3a}, R^{3b}, R^{3c}, R^{3d}, R^{5a}, R^{5b}, R^{5c}, and R^{5d} are each H.

The compound according to any preceding aspect, wherein M² and M⁵ are both null, and R^{3a}, R^{3b}, R^{3c}, R^{3d}, R^{5a}, R^{5b}, R^{5c}, and R^{5d} are each F.

The compound according to any preceding aspect, wherein M³ and M⁵ are both null, R^{3a}, R^{3c}, R^{5a}, and R^{5c} are each F, and R^{3b}, R^{3d}, R^{5b}, and R^{5d} are each H.

The compound according to any preceding aspect, wherein M² and M⁵ are both null, and R^{3a} and R^{5a} are each CH₃, and R^{3b}, R^{3c}, R^{3d}, R^{5b}, R^{5c}, and R^{5d} are each H,

The compound according to any preceding aspect, wherein R¹ is CH₃, CH(CH₃)₂, CF₃, CH₂CF₃, benzyl, or phenyl.

The compound according to any preceding aspect, wherein a, c, and d are each 1, and b is 0.

The compound according to any preceding aspect, wherein the compound is a compound of Formula (5):

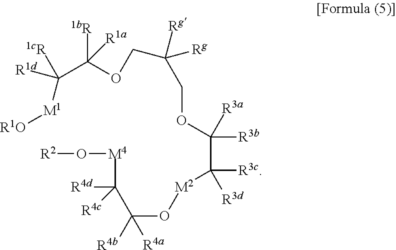

The compound according to any preceding aspect, wherein M¹, M², and M⁴ are each null.

The compound according to any preceding aspect, wherein M¹, M², and M⁴ are each null, and R^{1a}, R^{1b}, R^{1c}, R^{1d}, R^{3a}, R^{3b}, R^{3c}, R^{3d}, R^{4a}, R^{4b}, R^{4c}, and R^{4d} are each H.

The compound according to any preceding aspect, wherein M¹, M², and M⁴ are each null, and R^{1a}, R^{1b}, R^{1c}, R^{1d}, R^{3a}, R^{3b}, R^{3c}, R^{3d}, R^{4a}, R^{4b}, R^{4c}, and R^{4d} are each F.

The compound according to any preceding aspect, wherein M¹, M², and M⁴ are each null, R^{1a}, R^{1c}, R^{3a}, R^{3c}, R^{4a}, and R^{4d} are each F, and R^{1b}, R^{1d}, R^{3b}, R^{3d}, R^{4b}, and R^{4d} are each H.

The compound according to any preceding aspect, wherein M¹, M², and M⁴ are each null, and R^{1a}, R^{3a}, and R^{4a} are each CH₃, and R^{1b}, R^{1c}, R^{1d}, R^{3b}, R^{3c}, R^{3d} R^{4b}, R^{4c}, and R^{4d} are each H.

The compound according to any preceding aspect, wherein R^{g} and R^{g′} together form an oxo.

The compound according to any preceding aspect, wherein R^{g} is H and R^{g′} is OR³.

The compound according to any preceding aspect, wherein R³ is CH₃, CH(CH₃)₂, CF₃, CH₂CF₃, benzyl, or phenyl.

The compound according to any preceding aspect, wherein a and b are both 0, and c, d, and e are each 1.

The compound according to any preceding aspect, wherein the compound is a compound of Formula (6):

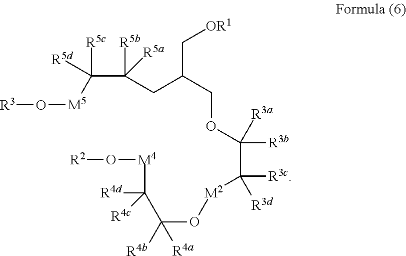

The compound according to any preceding aspect, wherein M², M⁴, and M⁵ are each null.

The compound according to any preceding aspect, wherein M², M⁴, and M⁵ are each null, and R^{3a}, R^{3b}, R^{3c}, R^{3d}, R^{4a}, R^{4b}, R^{4c}, R^{4d}, R^{5a}, R^{5b}, R^{5c}, and R^{5d} are each H.

The compound according to any preceding aspect, wherein M², M⁴, and M⁵ are each null, and R^{3a}, R^{3b}, R^{3c}, R^{3d}, R^{4a}, R^{4b}, R^{4c}, R^{4d}, R^{5a}, R^{5b}, R^{5c}, and R^{5d} are each F.

The compound according to any preceding aspect, wherein M², M⁴, and M⁵ are each null, R^{3a}, R^{3c}, R^{4a}, R^{4c}, R^{5a}, and R^{5d} are each F, and R^{3b}, R^{3d}, R^{4b}, R^{4d}, R^{5b}, and R^{5d} are each H.

The compound according to any preceding aspect, wherein M², M⁴, and M⁵ are each null, and R^{3a}, R^{4a}, and R^{5a} are each CH₃, and R^{4b}, R^{4c}, R^{4d}, R^{4b}, R^{4c}, R^{4d} R^{5b}, R^{5c}, and R^{5d} are each H.

The compound according to any preceding aspect, wherein R¹ can be CH₃, CH(CH₃)₂, CF₃, CH₂CF₃, benzyl, or phenyl.

The compound according to any preceding aspect, wherein a, b, c, and d are each 1.

The compound according to any preceding aspect, wherein the compound is a compound of Formula (7):

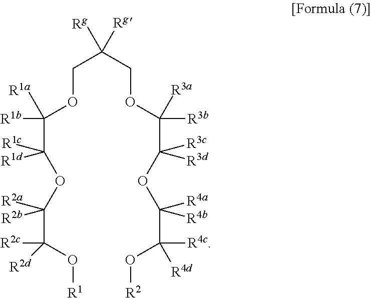

The compound according to any preceding aspect, wherein R^{1a}, R^{1b}, R^{1c}, R^{1d}, R^{2a}, R^{2b}, R^{2c}, R^{2d}, R^{3a}, R^{3b}, R^{3c}, R^{3d}, R^{4a}, R^{4b}, R^{4c}, and R^{4d} are each H.

The compound according to any preceding aspect, wherein R^{1a}, R^{1b}, R^{1c}, R^{1d}, R^{2a}, R^{2b}, R^{2c}, R^{2d}, R^{3a}, R^{3b}, R^{3c}, R^{3d}, R^{4a}, R^{4b}, R^{4c}, and R^{4d} are each F.

The compound according to any preceding aspect, wherein R^{1a}, R^{1c}, R^{2a}, R^{2c}, R^{3a}, R^{3c}, R^{4a}, and R^{4d} are each F, and R^{1b}, R^{1d}, R^{2a}, R^{2c}, R^{3b}, R^{3d}, R^{4b}, and R^{4d} are each H.

The compound according to any preceding aspect, wherein R^{1a}, R^{2a}, R^{3a}, and R^{4a} are each CH₃, and R^{1b}, R^{1c}, R^{1d}, R^{2b}, R^{2c}, R^{2d}, R^{3b}, R^{3c}, R^{3d}, R^{4b}, R^{4c}, and R^{4d} are each H.

The compound according to any preceding aspect, wherein R^{g} and R^{g′} together form an oxo.

The compound according to any preceding aspect, wherein R^{g} is H and R^{g′} is OR³.

The compound according to any preceding aspect, wherein R³ can be CH₃, CH(CH₃)₂, CF₃, CH₂CF₃, benzyl, or phenyl.

The compound according to any preceding aspect, wherein c, d, e, and f are each 1.

The compound according to any preceding aspect, wherein M³, M⁴, M⁵, and M⁶ are each null.

The compound according to any preceding aspect, wherein the compound is a compound of Formula (8):

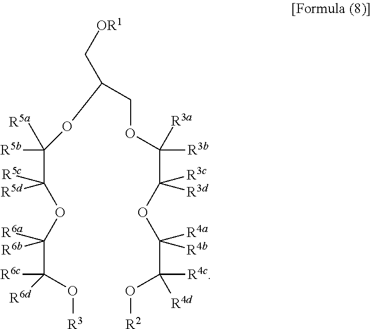

The compound according to any preceding aspect, wherein R^{3a}, R^{3b}, R^{3c}, R^{3d}, R^{4a}, R^{4b}, R^{4c}, R^{4d}, R^{5a}, R^{5b}, R^{5c}, R^{5d}, R^{5a}, R^{6b}, R^{6c}, and R^{6d} are each H.

The compound according to any preceding aspect, wherein R^{3a}, R^{3b}, R^{3c}, R^{3d}, R^{4a}, R^{4b}, R^{4c}, R^{4d}, R^{5a}, R^{5b}, R^{5c}, R^{5d}, R^{6a}, R^{6b}, R^{6c}, and R^{6d} are each F.

The compound according to any preceding aspect, wherein R^{3a}, R^{3c}, R^{4a}, R^{4c}, R^{5a}, R^{5c}, R^{6a}, and R^{6d} are each F, and R^{3b}, R^{3d}, R^{4a}, R^{4c}, R^{5b}, R^{5d}, R^{6b}, and R^{6d} are each H.

The compound according to any preceding aspect, wherein R^{3a}, R^{4a}, R^{5a}, and R^{6a} are each CH₃, and R^{3b}, R^{3c}, R^{3d}, R^{4b}, R^{4c}, R^{4d}, R^{5b}, R^{5c}, R^{5d}, R^{6b}, R^{6c}, and R^{6d} are each H.

The compound according to any preceding aspect, wherein R^{g} and R^{g′} together form an oxo.

The compound according to any preceding aspect, wherein R^{g} is H and R^{g′} is OR¹.

The compound according to any preceding aspect, wherein R¹ is CH₃, CH(CH₃)₂, CF₃, CH₂CF₃, benzyl, or phenyl.

100. A method of separating a metal from an aqueous liquid, comprising contacting the liquid with a solvent comprising a compound according to any preceding aspect and then separating the liquid from the solvent.

The method according to aspect 100, wherein the metal comprises a metal in the +1 oxidation state, the +2 oxidation state, the +3 oxidation state, the +4 oxidation state, the +5 oxidation state, the +6 oxidation state, the +7 oxidation state, or a combination thereof. The method according to any preceding aspect, wherein the metal comprises Li, Al, Co, Cr, Cu, La, Mn, Ni, Y, Ce, La, Nd, Tb, Dy, Sc, Pr, Eu, Sm, Lu, Gd, Er, Ho, Tm, Yb, U, or a combination thereof.

The method according to aspect 101, wherein the metal comprises Li⁺, Al³⁺, Co²⁺, Cr³⁺, Cu²⁺, La³⁺, Mn²⁺, Ni²⁺, Y³⁺, U⁴⁺, or a combination thereof.

The method according to aspect 100 or 101, wherein the metal comprises Li⁺.

The method according to aspect 100 or 101, wherein the metal comprises Nd⁺.

The method according to any of aspects 100-104 wherein the solvent further comprises a C₇₋₁₈hydrocarbon.

The method according to aspect 105, wherein the solvent comprises the compound and the C₇₋₁₈hydrocarbon in a (v/v) ratio of from 1:20 to 5:1, from 1:10 to 1:1, from 1:10 to 1:5, from 1:5 to 1:1, from 1:5 to 5:1, from 1:2.5 to 1:1.25, from 1:1 to 1:2.5, or from 1:1 to 1:5.

The method according to any of aspects 100-106, wherein the solvent further comprises a xylene, mesitylene, decane, undecane, dodecane.

The method according to any of aspects 100-107, wherein the solvent further comprises a hydrocarbon having a boiling point of at least 125° C.

The method according to any of aspects 100-108, further comprising separating the metal from the separated solvent.

The method according to any of aspects 100-109, further comprising precipitating the metal from the separated solvent.

The method according to aspect 110, wherein the precipitating comprises contacting the separated solvent with an acid, a base, or a combination thereof.

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated. The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than in the examples, or where otherwise noted, all numbers expressing quantities of ingredients, reaction conditions, and so forth used in the specification and claims are to be understood at the very least, and not as an attempt to limit the application of the doctrine of equivalents to the scope of the claims, to be construed in light of the number of significant digits and ordinary rounding approaches

What is claimed is:

1. A compound of Formula (1): 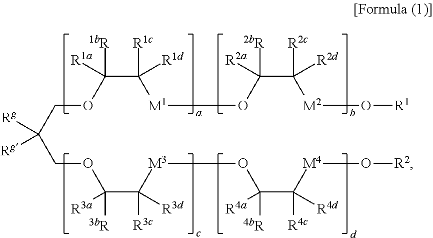
wherein R^{g} and R^{g′} together form an oxo (i.e., ═O), ═NR², or R^{g} is H and R^{g′} is OR^{z} or NHR^{z}, wherein R^{z} has the formula 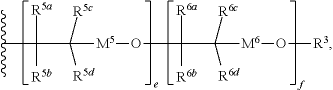
R¹ is H, C₁₋₆alkyl, aryl, C₁₋₆alkaryl, or C₁₋₆haloalkyl;
R² is H, C₁₋₆alkyl, aryl, C₁₋₆alkaryl, or C₁₋₆haloalkyl;
R³ is H, C₁₋₆alkyl, aryl, C₁₋₆alkaryl, or C₁₋₆haloalkyl;
M¹ is null, CR^{1e}R^{1f}, or CR^{1e}R^{1f}CR^{1g}R^{1h};
M² is null, CR^{2e}R^{2f}, or CR^{2e}R^{2f}CR^{2g}R^{2h};
M³ is null, CR^{3e}R^{3f}, or CR^{3e}R^{3f}CR^{3g}R^{3h};
M⁴ is null, CR^{4e}R^{4f}, or CR^{4e}R^{4f}CR^{4g}R^{4h};
M⁵ is null, CR^{5e}R^{5f}, or CR^{5e}R^{5f}CR^{5g}R^{5h};
M⁶ is null, CR^{6e}R^{6f}, or CR^{5e}R^{6f}CR^{6g}R^{6h};
R^{1a}, R^{1b}, R^{1c}, R^{1d}, R^{1e}, R^{1f}m R^{1g}, R^{1h}, R^{2a}, R^{2b}, R^{2c}, R^{2d}, R^{2e}, R^{2f}, R^{2g}, R^{2h}, R^{3a}a, R^{3b}, R^{3c}, R^{3d}, R^{3e}, R^{3f}, R^{3g}, R^{3h} R^{4a}, R^{4b}, R^{4c}, R^{4d}, R^{5a}, R^{5b}, R^{5c}, R^{5d}, R^{5e}, R^{5f}, R^{5g}, R^{5h}, R^{6a}, R^{6b}, R^{6c}, R^{6d}, R^{6e}, R^{6f}, R^{6g}, and R^{6h} are each independently selected from H, CH₃, F, CH₂F, CHF₂, or CF₃; and
a, b, c, d, e, and f are each independently selected from 0 or 1, provided that the sum of [a+b+c+d+e+f] is 2 or more.

2. The compound according to claim 1, wherein M¹, M², M³, M⁴, M⁵, and M⁶ are each null.

3. The compound according to claim 2, wherein R¹ R², and R³ are independently selected from CH₃, CH(CH₃)₂, CF₃, CH₂CF₃, benzyl, or phenyl.

4. The compound according to claim 2, wherein R¹, R², and R³ are each the same.

5. The compound according to claim 2, wherein R¹ and R² are each the same and R³ is different from R¹ and R².

6. The compound according to claim 2, wherein R² and R³ are each the same and R¹ is different from R² and R³.

7. The compound according to claim 2, wherein R^{g} and R^{g′} together form an oxo, and R¹ and R² are not the same.

8. The compound according to claim 2, wherein R^{g} and R^{g′} together form an oxo, and R¹ is CH₃ or CH(CH₃)₂, and R² is CH₂CF₃.

9. The compound according to claim 2, wherein R^{g} and R^{g′} together form an oxo, and R¹ and R² both CH(CH₃)₂.

10. The compound according to claim 2, wherein R¹ and R² are each CH(CH₃)₂, and R³ is CH₂CF₃.

11. A method of separating a metal from an aqueous liquid, comprising contacting the aqueous liquid with a solvent comprising a compound according to claim 1, and then separating the aqueous liquid from the solvent.

12. The method according to claim 11, wherein the metal comprises Li, Al, Co, Cr, Cu, La, Mn, Ni, Y, Ce, La, Nd, Tb, Dy, Sc, Pr, Eu, Sm, Lu, Gd, Er, Ho, Tm, Yb, U, or a combination thereof.

13. The method according to claim 11, wherein the metal comprises Li⁺.

14. The method according to claim 11, wherein the metal comprises Nd⁺.

15. The method according to claim 11 wherein the solvent further comprises a C₇₋₁₈hydrocarbon.

16. The method according to claim 11, further comprising precipitating the metal from the separated solvent.

17. A method of separating Nd³⁺ from an aqueous composition comprising Nd³⁺, comprising contacting the aqueous composition with an organic solvent comprising a compound of Formula (9): 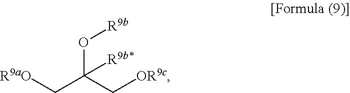
to provide an Nd³⁺ enriched organic solvent, wherein
R^{9a} is H or C₁₋₁₂alkyl, optionally substituted one or more times by F, Cl, Br, or OC₁₋₄alkyl,
R^{9c} is H or C₁₋₁₂alkyl, optionally substituted one or more times by F, Cl, Br, or OC₁₋₄alkyl
R^{9b*} is H, R^{9b} is H or C₁₋₁₂alkyl, optionally substituted one or more times by F, Cl, Br, or OC₁₋₄alkyl or R^{9b*} and R^{9b} together form a bond,
provided that:
no more than one of R^{9a}, R^{9b}, and R^{9c} are H, and
when R^{9b*} and R^{9b} together form a bond, neither of R^{9a} or R^{9c} are H; and
separating the Nd³⁺ enriched organic solvent from the aqeuous composition.

18. The method according to claim 17, wherein the compound of Formula (9) comprises a compound of Formula (9k): 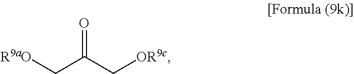
a compound of Formula (9h): 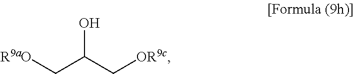
or a combination thereof.

19. The method of claim 17, wherein the aqueous composition comprising Nd³⁺ is obtained from a permanent magnet.

20. The method of claim 17, further comprising separating Nd³⁺ from the compound of Formula (9).
